(19) United States
(12) Patent Application Publication
(10) Pub. No.: US 2026/0186228 A1
(43) Pub. Date: Jul. 2, 2026

(54) METHOD FOR ASSEMBLING CAMERA OPTICAL LENS, AND CAMERA OPTICAL LENS

(71) Applicant: Changzhou AAC Raytech Optronics Co., Ltd., Changzhou City (CN)

(72) Inventors: Haopeng Zhou, Changzhou (CN); Zhiyun Zhang, Changzhou (CN); Shaoshi Shen, Changzhou (CN); Fan Li, Changzhou (CN)

(21) Appl. No.: 19/336,452

(22) Filed: Sep. 22, 2025

Related U.S. Application Data
(63) Continuation of application No. PCT/CN2024/144629, filed on Dec. 31, 2024.

(51) Int. Cl. G02B 7/00

(52) U.S. Cl. CPC G02B 7/003

(57) ABSTRACT

A method for assembling a camera optical lens, and a camera optical lens are provided. The method for assembling a camera optical lens performs a rough positioning process on a first group and a second group based on a visual inspection and a non-contact inspection. During the rough positioning process, the first group and the second group are relatively independent and do not have contact connection or adhesive connection, thereby simplifying assembling steps of the camera optical lens, and providing a basis for subsequent Active Alignment (AA) adjustment. If the AA adjustment fails, the AA adjustment can be performed again after one of the groups can be replaced in time, thereby improving the yield and material utilization rate of assembling the camera optical lens.

### TECHNICAL FIELD

The present disclosure relates to the field of camera assembly technologies, and in particular, to a method for assembling a camera optical lens, and a camera optical lens.

### BACKGROUND

Split multi-group lenses include a lens barrel component, an external lens and at least one internal camera optical lens. In the related art, a lens and a lens barrel need to be pre-assembled during the assembly process of the camera optical lens, and then adjusted in at least one direction according to the imaging quality. The defect of this method is that pre-assembly increases assembly procedures, and an adhesive is already dispensed onto two groups before active alignment (AA) detection and assembly adjustment of the two groups. If the AA adjustment fails, both groups can only be scrapped. It is not possible to replace one of the groups for re-assembly and adjustment, resulting in a low material utilization rate of the camera optical lens.

In view of this, it is necessary to provide a method for assembling a camera optical lens and a camera optical lens with simple assembly procedures and a high material utilization rate.

### SUMMARY

An object of the present disclosure is to provide a method for assembling a camera optical lens, and a camera optical lens, and the method for assembling a camera optical lens has simple assembly procedures and a high material utilization rate.

The technical solution of the present disclosure is as follows:

In a first aspect, the present disclosure provides a method for assembling a camera optical lens, including: step S1, respectively completing a rough positioning process of a first group and a second group based on a visual inspection and a non-contact height measurement inspection. The visual inspection is configured to determine a relative position between the first group and the second group, and the non-contact height measurement inspection is configured to detect a tilt angle and a height position of the first group and of the second group; and the second group is located on an image side of the first group, the first group includes a lens barrel and a lens group accommodated in the lens barrel, and the second group includes an image side lens. Step S2, after the rough positioning process in step S1, performing a posture adjustment of at least one degree of freedom on at least one of the first group and the second group to obtain qualified imaging performance, and measuring and recording a relative posture parameter of the first group and the second group based on the visual inspection and the non-contact height measurement inspection. Step S3, after processing in step S2, moving the first group or the second group to an adhesive dispensing station to dispense an adhesive. Step S4, after dispensing the adhesive, returning the first group or the second group to a position recorded in step S2 according to the relative posture parameter. Step S5, performing a curing treatment on the first group and the second group processed in step S4 to connect the first group and the second group to obtain a camera optical lens.

As an improvement, in step S1, a center deviation between the first group and the second group is within ±5 μm, and a tilt deviation between the first group and the second group is within ±0.01°.

As an improvement, the visual inspection includes the following steps: detecting a position of the first group and a position of the second group using a first visual inspection system and a second visual inspection system; and uniformly converting point position information of the first group and the second group detected by the first visual inspection system and the second visual inspection system to any visual inspection system, to confirm a relative position relationship between the first group and the second group.

As an improvement, in the visual inspection, the point position information of the first group and the second group detected by the first visual inspection system and the second visual inspection system are uniformly converted to the first visual inspection system using a conversion equation Equation 1:

$${A}^{} P = {}_{B}^{A} T * {}^{B} P ,$$

where ^{A}P is a spatial coordinate of the first visual inspection system, ^{B}P is a spatial coordinate of the second visual inspection system, and

$${}_{B}^{A} T$$

is a rotation matrix of a coordinate transformation between the first visual inspection system and the second visual inspection system.

As an improvement, the non-contact height measurement inspection includes the following steps: testing, by a non-contact height measurement sensor, heights of at least three position points in a plane to obtain height values of the at least three position points; and calculating a tilt angle of the plane according to the measured height values of the at least three position points and relative distance values between the at least three position points.

As an improvement, the non-contact height measurement sensor includes a laser triangulation sensor or a white-light confocal sensor.

As an improvement, in the non-contact height measurement inspection, the non-contact height measurement sensor used is the white-light confocal sensor; a number of the at least three position points is four, the at least three position points are respectively a first position point, a second position point, a third position point and a fourth position point, heights of the position points measured using the white-light confocal sensor are respectively h1, h2, h3 and h4, the first position point and the third position point are opposite to each other in a y-direction, a relative distance between the first position point and the third position point is d1, the second position point and the fourth position point are opposite to each other in a x-direction, and a relative distance between the second position point and the fourth position point is d2; and a tilt angle around a x-axis is calculated according to Equation 2:

$${T}_{x} = arctan \frac{h 3 - h 1}{d 1} ,$$

and an tilt angle around a y-axis is calculated according to Equation 3:

$${T}_{y} = arctan \frac{h 4 - h 2}{d 2} .$$

As an improvement, in step S2, the imaging performance includes one or more of Modulation Transfer Function (MTF), Spatial Frequency Response (SFR) or Television (TV)

### Line.

As an improvement, when the adhesive used in step S4 is an ultraviolet (UV) adhesive, the curing treatment includes a UV curing treatment or a thermal curing treatment in step S5.

In a second aspect, the present disclosure provides a camera optical lens, and the camera optical lens is assembled using the above method for assembling a camera optical lens.

The present disclosure has the following beneficial effects. According to the method for assembling a camera optical lens provided in the present disclosure, the rough positioning is performed on the first group and the second group based on the visual inspection and the non-contact inspection. During the rough positioning process, the first group and the second group are relatively independent and do not have contact connection or adhesive connection, thereby simplifying the assembling steps of the camera optical lens, and providing a basis for subsequent AA adjustment. If the AA adjustment fails, the AA adjustment can be performed again after one of the groups being replaced in time, thereby improving the yield and material utilization rate of assembling the camera optical lens.

### BRIEF DESCRIPTION OF DRAWINGS

FIG. 1 is an operation flowchart of a method for assembling a camera optical lens according to the present disclosure.

FIG. 2 is a schematic diagram of rough positioning of a first group and a second group.

FIG. 3 is a schematic flowchart of a visual inspection.

FIG. 4 is a schematic diagram of a visual inspection of a first group and a second group respectively using a first visual inspection system and a second visual inspection system.

FIG. 5 is a schematic flowchart of a non-contact height measurement inspection.

FIG. 6 is a schematic diagram of distribution of position points during a non-contact height measurement inspection.

FIG. 7 is a schematic diagram of a test structure for a reverse optical path MTF test.

FIG. 8 is a graph of an image plane tilt during x-direction scanning of the first group relative to the second group, where (a) is a graph of image tilt y, and (b) is a graph of image tilt x.

FIG. 9 is a schematic diagram of distribution of curing light sources around a camera optical lens during a UV curing treatment.

### REFERENCE SIGNS

1—first group,
   11—lens barrel,
   12—lens group,
2—second group,
   21—image side lens,
      111—image side surface of lens barrel,
      112—object side surface of lens barrel,
      211—object side surface of image side lens,
      212—image side surface of image side lens,
3—first visual inspection system,
4—second visual inspection system,
5—reticle assembly,
   51—lifting driving member,
   52—reticle,
6—first group driving member,
7—second group driving member,
8—performance testing system,
9—curing light source,
10—camera optical lens,
   P1—first point position information,
   P2—second point position information,
   P3—first position point,
   P4—second position point,
   P5—third position point,
   P6—fourth position point.

### DESCRIPTION OF EMBODIMENTS

The present disclosure will be further described below with reference to the accompanying drawings and embodiments.

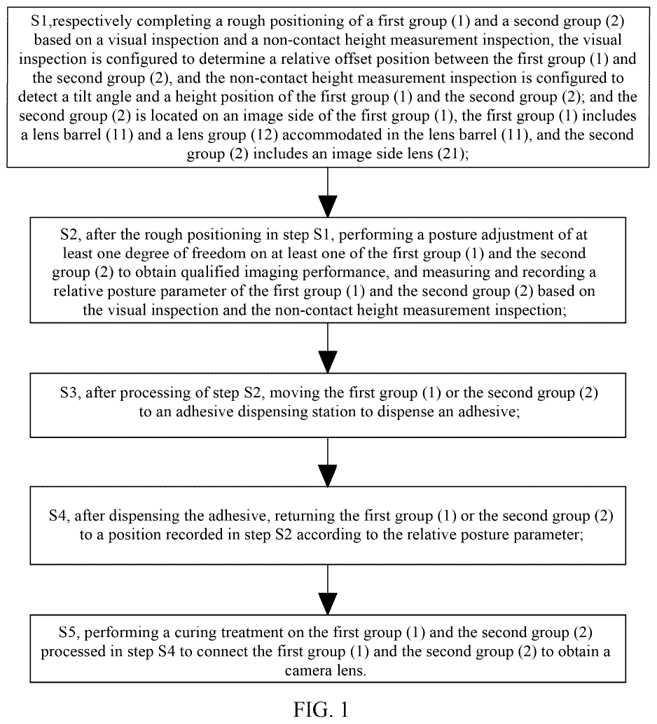

In a first aspect, the present disclosure provides a method for assembling a camera optical lens, as shown in FIG. 1, including the following steps:

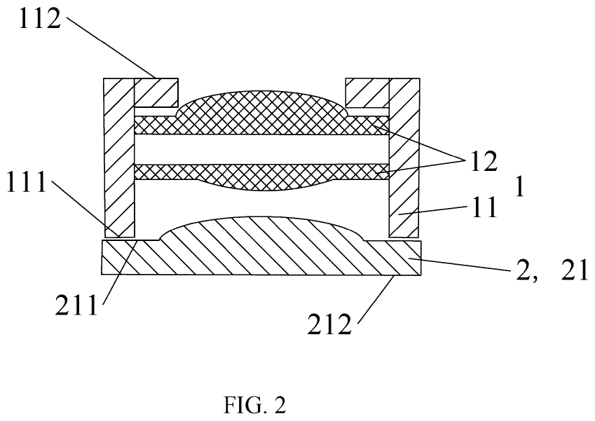

Step S1, a rough positioning is respectively completed on the first group 1 and the second group 2 based on a visual inspection and a non-contact height measurement inspection. The visual inspection is configured to determine a relative offset position between the first group 1 and the second group 2, and the non-contact height measurement inspection is configured to detect a tilt angle and a height position of the first group 1 and the second group 2. Referring to FIG. 2, the second group 2 is located on an image side of the first group 1. The first group 1 includes a lens barrel 11 and a lens group 12 accommodated in the lens barrel 11. The second group 2 includes an image side lens 21. It should be noted that in the present disclosure, a x-direction, a y-direction, and a z-direction are respectively arranged parallel to a x-axis, a y-axis, and a z-axis in a spatial coordinate system, and the x-direction, the y-direction, and the z-direction are arranged perpendicular to each other in space. Rx refers to rotation around the x-direction, and Ry refers to rotation around the y-direction. In the present disclosure, the roughly positioning of the first group 1 and the second group 2 mainly includes five degrees of freedom, which respectively include x, y, z, Rx and Ry. In an example, the relative offset position between the first group 1 and the second group 2 in the present disclosure refers to a relative offset of the first group 1 and the second group 2 along the x-axis and the y-axis. The tilt angle of the first group 1 and the second group 2 refers to Rx and Ry. The detection of the height position of the first group 1 and the second group 2 refers to a height of the first group 1 and the second group 2 along the z-axis.

Step S2, after the rough positioning in step S1, a posture adjustment of at least one degree of freedom is performed on at least one of the first group 1 and the second group 2 to obtain qualified imaging performance, and a relative posture parameter of the first group 1 and the second group 2 is measured and recorded based on the visual inspection and the non-contact height measurement inspection.

Step S3, after processing in step S2, the first group 1 or the second group 2 are moved to an adhesive dispensing station to dispense an adhesive.

Step S4, after dispensing the adhesive, the first group 1 or the second group 2 is returned to a position recorded in step S2 according to the relative posture parameter.

Step S5, a curing treatment is performed on the first group 1 and the second group 2 processed in step S4 to connect the first group 1 and the second group 2 to obtain a camera optical lens.

According to the method for assembling a camera optical lens provided in the present disclosure, the rough positioning is performed on the first group 1 and the second group 2 based on the visual inspection and the non-contact inspection. During the rough positioning process, the first group 1 and the second group 2 are relatively independent and do not have contact connection or adhesive connection, thereby simplifying the assembling steps of the camera optical lens, and providing a basis for subsequent AA adjustment. If the AA adjustment fails, the AA adjustment can be performed again after one of the groups can be replaced in time, thereby improving the yield and material utilization rate of assembling the camera optical lens.

Optionally, in step S1, a center deviation between the first group 1 and the second group 2 is within ±5 μm, a tilt deviation between the first group 1 and the second group 2 is within ±0.01°.

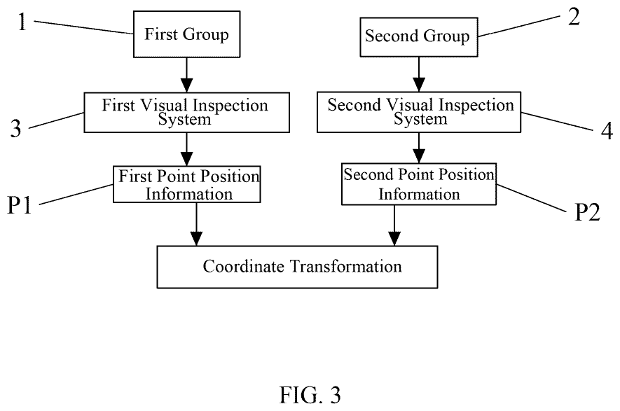

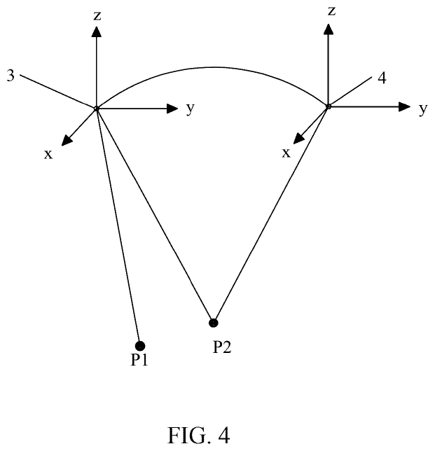

Optionally, referring to FIG. 3, the visual inspection includes the following steps: a position of the first group 1 and a position of the second group 2 are respectively detected using the first visual inspection system 3 and the second visual inspection system 4 to obtain the first point position information P1 and the second point position information P2. Point position information of the first group 1 and the second group 2 detected by the first visual inspection system 3 and the second visual inspection system 4 is uniformly converted to any visual inspection system, to confirm a relative position relationship between the first group 1 and the second group 2. FIG. 4 is a schematic diagram of a visual inspection of the first group 1 and the second group 2 using the first visual inspection system 3 and the second visual inspection system 4.

Optionally, during the visual inspection, the point position information of the first group 1 and the second group 2 detected by the first visual inspection system 3 and the second visual inspection system 4 are uniformly converted to the first visual inspection system 3 using a conversion equation Equation 1:

$${A}^{} P = {}_{B}^{A} T * {}^{B} P ,$$

where ^{A}P is a spatial coordinate of the first visual inspection system 3, ^{B}P is a spatial coordinate of the second visual inspection system 4, and

$${}_{B}^{A} T$$

is a rotation translation matrix of a coordinate transformation between the first visual inspection system 3 and the second visual inspection system 4.

The first visual inspection system 3 and the second visual inspection system 4 both include a visual camera, a camera optical lens, and a light source. When in use, the camera optical lens is arranged towards the light source, the light source exposes the group to be inspected, and the visual camera collects images of the group to be inspected.

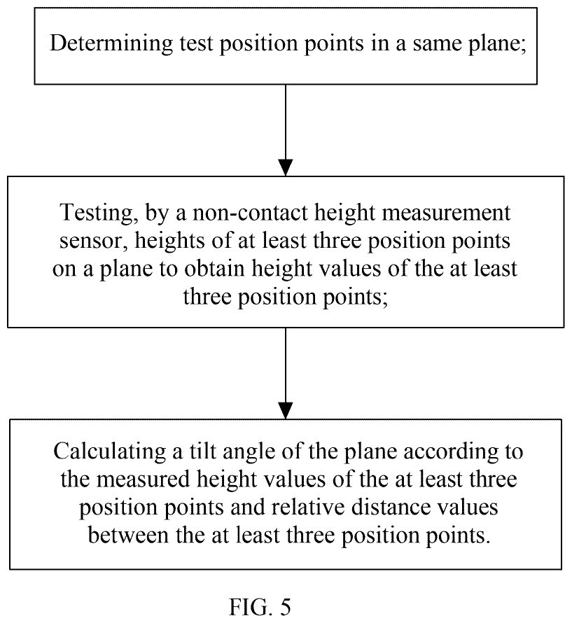

Optionally, referring to FIG. 5, the non-contact height measurement inspection includes the following steps: test position points are determined on a same plane; heights of at least three position points in a plane are tested by a non-contact height measurement sensor, to obtain height values of the at least three position points; and a tilt angle of the plane is calculated according to the measured height values of the at least three position points and relative distance values between the at least three position points. The plane detected by the non-contact height measurement inspection includes an image side surface 111 of the lens barrel or an object side surface 112 of the lens barrel, or an object side surface 211 of the image side lens or an image side surface 212 of the lens barrel.

Optionally, the non-contact height measurement sensor includes a laser triangulation sensor or a white-light confocal sensor.

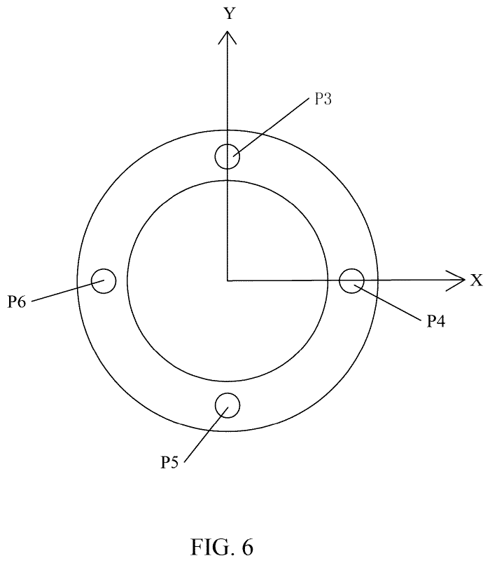

Optionally, in the non-contact height measurement inspection, the non-contact height measurement sensor used is the white-light confocal sensor. As shown in FIG. 6, a number of the position points selected on a same plane is four, and the position points are respectively a first position point P3, a second position point P4, a third position point P5 and a fourth position point P6. Heights of the position points measured using the white-light confocal sensor are respectively h1, h2, h3 and h4. The first position point P3 and the third position point P5 are opposite to each other in the y-direction, and a relative distance between the first position point P3 and the third position point P5 is d1. The second position point P4 and the fourth position point P6 are opposite to each other in the x-direction, and a relative distance between the second position point P4 and the fourth position point P6 is d2. A tilt angle around the x-axis is calculated according to Equation 2:

$${T}_{x} = arctan \frac{h 3 - h 1}{d 1} ,$$

and a tilt angle around the y-axis is calculated according to Equation 3:

$${T}_{y} = arctan \frac{h 4 - h 2}{d 2} .$$

In step S2, the imaging performance includes one or more of MTF, SFR or TV Line. MTF is an abbreviation of Modulation Transfer Function, SFR is an abbreviation of Spatial Frequency Response, and TV Line is an abbreviation of Television Line.

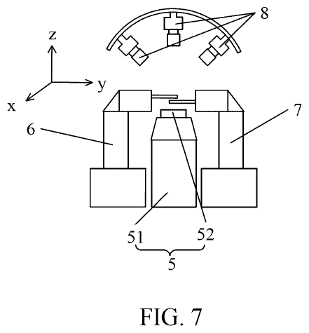

The preliminary camera optical lens imaging performance and the camera optical lens imaging performance after the posture adjustment may be performed by means of a reverse optical path or a forward optical path. Taking a MTF performance test by means of the reverse optical path as an example, the test of camera optical lens imaging performance is explained as follows. As shown in FIG. 7, a device for testing the reverse optical path includes a reticle assembly 5 arranged along the z-direction, a first group driving member 6 and a second group driving member 7 that are arranged on two sides of the reticle assembly 5, and a performance testing system 4 arranged on a top of the reticle assembly 5. The reticle assembly 5 includes a lifting driving member 51 and a reticle 52 driven by the lifting driving member 51. The first group driving member 6 and the second group driving member 7 are configured to respectively drive the first group 1 and the second group 2 to move. In an example, the performance testing system 8 may be an MTF tester. The MTF performance test by means of the reverse optical path includes the following steps: the lifting driving member drives the reticle to move, thereby changing a camera optical lens image distance of the camera optical lens in the visual inspection system, and calculating the MTF of multiple field points at the same time, so as to draw a set of defocus curves. The image plane tilt can be calculated based on the obtained defocus curves. The calculation equation of the image plane tilt in the y-direction is shown as Equation 4:

$$Image titl y = arc tan \frac{shift}{image high} ,$$

where shift is a field curvature, image high is an image height. Correspondingly, an image tilt x value can be obtained.

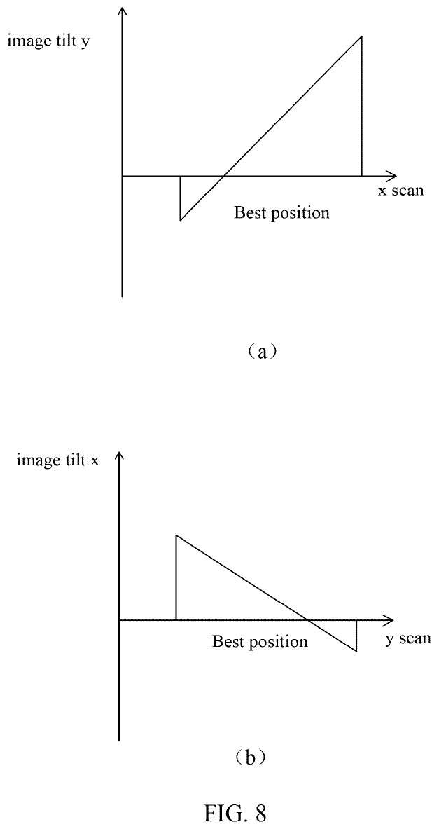

In an example, the second group 2 is fixed, and the first group 1 performs a scanning movement in the x-direction relative to the second group 2. The image tilt x and the image tilt y are calculated once for each position during movement, and a fitting curve is respectively obtained. Referring to FIG. 8, an intersection point of the fitting calculation curve and the abscissa is an optimal position point of the first group 1 relative to the second group 2.

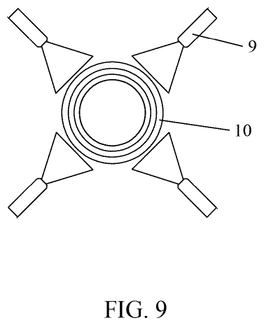

Optionally, when the adhesive used in step S4 is a UV adhesive, the curing treatment includes a UV curing treatment or a thermal curing treatment in step S5. When adopting the UV curing treatment, curing light sources 9 are evenly distributed along a circumferential direction of the camera optical lens 10 to ensure the uniformity of the UV curing treatment of the adhesive. In an example, referring to FIG. 9, 4-point UV irradiation is adopted, and the number of the curing light sources 9 is four. When adopting the thermal curing treatment, a temperature of the thermal curing treatment is 80±3° C. In an example, when adopting the thermal curing treatment, the camera optical lens is first subjected to UV curing treatment, and then the camera optical lens after the UV curing treatment is subjected to the thermal curing treatment at 80±3° C.

In a second aspect, the present disclosure provides a camera optical lens, and the camera optical lens is assembled using the above method for assembling a camera optical lens.

The above description merely illustrates some embodiments of the present disclosure, and it should be noted that those skilled in the art can also make improvements without departing from a concept of the present disclosure, but these all improvements fall within a protection scope of the present disclosure.

What is claimed is:

1. A method for assembling a camera optical lens, comprising:
step S1, respectively completing a rough positioning process of a first group and a second group based on a visual inspection and a non-contact height measurement inspection, wherein the visual inspection is configured to determine a relative offset position between the first group and the second group, and the non-contact height measurement inspection is configured to detect a tilt angle and a height position of the first group and of the second group; and the second group is located on an image side of the first group, the first group comprises a lens barrel and a lens group accommodated in the lens barrel, and the second group comprises an image side lens;
step S2, after the rough positioning process in step S1, performing a posture adjustment of at least one degree of freedom on at least one of the first group and the second group to obtain qualified imaging performance, and measuring and recording a relative posture parameter of the first group and the second group based on the visual inspection and the non-contact height measurement inspection;
step S3, after processing in step S2, moving the first group or the second group to an adhesive dispensing station to dispense an adhesive;
step S4, after dispensing the adhesive, returning the first group or the second group to a position recorded in step S2 according to the relative posture parameter; and
step S5, performing a curing treatment on the first group and the second group processed in step S4 to connect the first group and the second group to obtain a camera optical lens.

2. The method for assembling a camera optical lens as described in claim 1, wherein in step S1, a center deviation between the first group and the second group is within ±5 μm, and a tilt deviation between the first group and the second group is within ±0.01°.

3. The method for assembling a camera optical lens as described in claim 1, wherein the visual inspection comprises: detecting a position of the first group and a position of the second group using a first visual inspection system and a second visual inspection system; and uniformly converting point position information of the first group and the second group detected by the first visual inspection system and the second visual inspection system to any visual inspection system, to confirm a relative position relationship between the first group and the second group.

4. The method for assembling a camera optical lens as described in claim 3, wherein in the visual inspection, the point position information of the first group and the second group detected by the first visual inspection system and the second visual inspection system are uniformly converted to the first visual inspection system using a conversion equation Equation 1:
$${A}^{} P = {}_{B}^{A} T * {}^{B} P ,$$
where ^{A}P is a spatial coordinate of the first visual inspection system, ^{B}P is a spatial coordinate of the second visual inspection system, and
$${}_{B}^{A} T$$
is a rotation translation matrix of a coordinate transformation between the first visual inspection system and the second visual inspection system.

5. The method for assembling a camera optical lens as described in claim 1, wherein the non-contact height measurement inspection comprises: testing, by a non-contact height measurement sensor, heights of at least three position points in a plane to obtain height values of the at least three position points; and calculating a tilt angle of the plane according to the measured height values of the at least three position points and relative distance values between the at least three position points.

6. The method for assembling a camera optical lens as described in claim 5, wherein the non-contact height measurement sensor comprises a laser triangulation sensor or a white-light confocal sensor.

7. The method for assembling a camera optical lens as described in claim 6, wherein in the non-contact height measurement inspection, the non-contact height measurement sensor used is the white-light confocal sensor; a number of the at least three position points is four, the at least three position points are respectively a first position point, a second position point, a third position point and a fourth position point, heights of the position points measured using the white-light confocal sensor are respectively h1, h2, h3 and h4, the first position point and the third position point are opposite to each other in a y-direction, a relative distance between the first position point and the third position point is d1, the second position point and the fourth position point are opposite to each other in a x-direction, and a relative distance between the second position point and the fourth position point is d2; and a tilt angle around a x-axis is calculated according to Equation 2:
$${T}_{x} = arctan \frac{h 3 - h 1}{d 1} ,$$
and a tilt angle around a y-axis is calculated according to Equation 3:
$${T}_{y} = arctan \frac{h 4 - h 2}{d 2} .$$

8. The method for assembling a camera optical lens as described in claim 1, wherein in step S2, the imaging performance comprises one or more of Modulation Transfer Function (MTF), Spatial Frequency Response (SFR) or Television (TV) Line.

9. The method for assembling a camera optical lens as described in claim 1, wherein when the adhesive used in step S4 is an ultraviolet (UV) adhesive, the curing treatment comprises a UV curing treatment or a thermal curing treatment in step S5.

10. A camera optical lens, wherein the camera optical lens is assembled using the method for assembling a camera optical lens as described in claim 1.
